(19) United States
(12) Patent Application Publication
(10) Pub. No.: US 2008/0080761 A1
(43) Pub. Date: Apr. 3, 2008

(54) Apparatus and method for generating stereoscopic image

(75) Inventors: Tung-Lin Hsien, Tao Yuan Shien (TW); Hsu-Hung Chen, Taipei Shien (TW); Maw-Lin Hsu, Yilan Shien (TW); Yu-Wen Huang, Taipei Shien (TW); Wan-Ching Lee, Taipei Shien (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/878,552

(22) Filed: Jul. 25, 2007

(30) Foreign Application Priority Data
Oct. 3, 2006 (TW) 095136635

(51) Int. Cl. G06T 15/20

(52) U.S. Cl. 382/154

(57) ABSTRACT

The invention discloses an apparatus and a method for generating an adaptive stereoscopic image by using a first-eye-viewed image and a second-eye-viewed image, which are captured relative to a scene. The apparatus, according to the invention, overlaps and horizontally shifts the first-eye-viewed image and the second-eye-viewed image until a horizontal difference is substantially at a minimum, and then vertically shifting the first-eye-viewed image and the second-eye-viewed image until a vertical difference is substantially at a minimum. The shifted image is the adaptive stereoscopic image.

### BACKGROUND OF THE INVENTION

1. Field of the Invention

This present invention relates to an apparatus and method for adjusting a stereoscopic image, and more particularly, relates to an apparatus and method for generating an adaptive stereoscopic image by adjusting the shifts between a first-eye-viewed image and a second-eye-viewed image.

2. Description of the Prior Art

Because of the difference between the positions of the left eye and the right eye, the images seen by the left eye and the right eye are somewhat different. If the left eye receives only the needed information for the left eye, and the right eye receives only the needed information for the right eye, the brain can be cheated to generate a stereoscopic image. The current method for establishing a stereoscopic image is usually synthesized from two 2D images received by the left eye and the right eye respectively. The shake caused in the shooting process or man-made vibrations will induce the up-down and/or left-right shifting between the left-eye image and the right-eye image. However, an excessive image shift leads to poor stereoscopic effect after the image synthesis, and the image with such defect is usually thrown away, which makes both the efficiency of producing stereoscopic images and the successful efficiency of synthesizing images impossible. Therefore, an apparatus for adjusting the images received by the left eye and the right eye is needed to compensate unexpected shift to efficiently synthesize stereoscopic images.

Accordingly, the invention provides an apparatus and method for generating an adaptive stereoscopic image by adjusting the shifts between a first-eye-viewed image and a second-eye-viewed image so as to solve the problems mentioned above.

### SUMMARY OF THE INVENTION

A scope of the invention is to provide an apparatus and method for generating an adaptive stereoscopic image by adjusting the shifts between a first-eye-viewed image and a second-eye-viewed image.

According to a preferred embodiment, an apparatus of the invention generates an adaptive stereoscopic image by using a first-eye-viewed image and a second-eye-viewed image. The first-eye-viewed image and the second-eye-viewed image are captured from a scene. The apparatus includes a receiving module, a first processing module, and a second processing module. The receiving module is configured to receive input of the first-eye-viewed image and the second-eye-viewed image. The first processing module is coupled to the receiving module. The second processing module is coupled to the first processing module.

The first processing module overlaps the first-eye-viewed image and the second-eye-viewed image. Then the first processing module horizontally shifts the second-eye-viewed image with respect to the first-eye-viewed image until a horizontal difference between the first-eye-viewed image and the second-eye-viewed image is substantially at a minimum. The second processing module receives the overlapped image of the first-eye-viewed image and the second-eye-viewed image, which have been horizontally shifted. Then the second processing module vertically shifts the second-eye-viewed image with respect to the first-eye-viewed image until a vertical difference between the first-eye-viewed image and the second-eye-viewed image is substantially at a minimum. Afterwards the second processing module obtains the overlapped image of the first-eye-viewed image and the second-eye-viewed image, which have been horizontally shifted, to be the adaptive stereoscopic image.

Consequently, the first processing module of the apparatus of the invention obtains the horizontal shift between the first-eye-viewed image and the second-eye-viewed image after horizontally shifting them. Similarly, the second processing module of the apparatus obtains the vertical shift between the first-eye-viewed image and the second-eye-viewed image after vertically shifting them. The horizontal shift and the vertical shift are the required shifts for correctly synthesizing the first-eye-viewed image and the second-eye-viewed image.

The advantage and spirit of the invention may be understood by the following recitations together with the appended drawings.

### BRIEF DESCRIPTION OF THE APPENDED DRAWINGS

FIG. 1A is a function block diagram illustrating an apparatus according to a preferred embodiment of the invention.

FIG. 1B is a sketch diagram illustrating the horizontally shifting of the first-eye-viewed image and the second-eye-viewed image.

FIG. 1C is a curve diagram of horizontal shift amount to horizontal difference.

FIG. 1D is a curve diagram of vertical shift amount to vertical difference.

FIG. 1E is a sketch diagram illustrating the vertically shifting of the first-eye-viewed image and the second-eye-viewed image.

FIG. 2A is a sketch diagram illustrating a capture position for a single-lens camera.

FIG. 2B is a sketch diagram illustrating a desktop computer and a notebook with two webcams.

FIG. 3 is a flow chart according to the preferred embodiment.

### DETAILED DESCRIPTION OF THE INVENTION

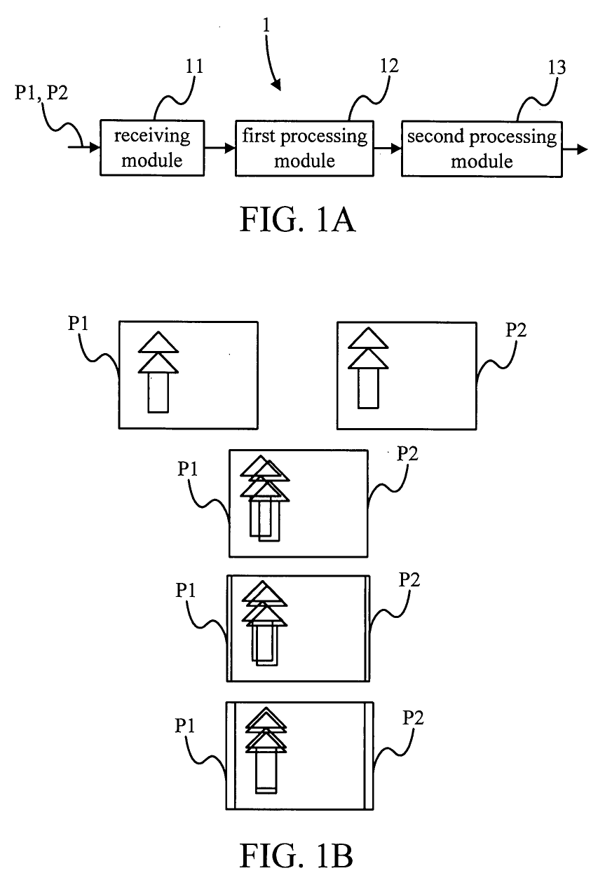

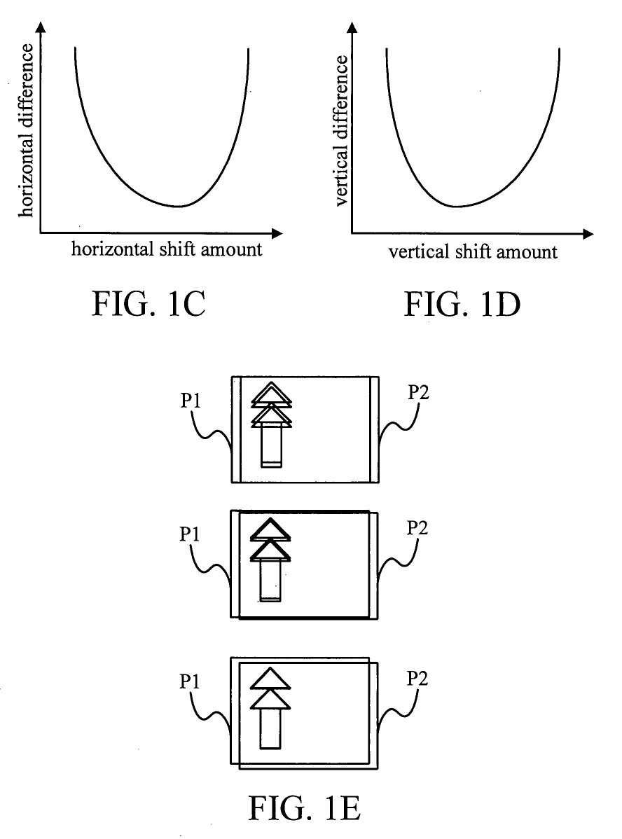

Please refer to FIG. 1A. FIG. 1A is a function block diagram illustrating an apparatus 1 according to a preferred embodiment of the invention. According to the preferred embodiment, the apparatus 1 includes a receiving module 11, a first processing module 12, and a second processing module 13. The receiving module 11 is configured to receive a first-eye-viewed image P1 and a second-eye-viewed image P2. The first processing module 12 is coupled to the receiving module 11. The second processing module 13 is coupled to the first processing module 12.

The first-eye-viewed image P1 and the second-eye-viewed image P2 are transmitted from the receiving module 11 to the first processing module 12. The first processing module 12 overlaps the first-eye-viewed image P1 and the second-eye-viewed image P2. Then the first processing module 12 horizontally shifts the second-eye-viewed image P2 with respect to the first-eye-viewed image P1 until a horizontal difference between the first-eye-viewed image P1 and the second-eye-viewed image P2 is substantially at a minimum. As shown in FIG. 1B, FIG. 1B is a sketch diagram illustrating the horizontally shifting of the first-eye-viewed image P1 and the second-eye-viewed image P2. The sketch diagram includes four parts. The first part, which is the uppermost part of FIG. 1B, illustrates a sketch diagram illustrating the horizontally shifting of the first-eye-viewed image P1 and the second-eye-viewed image P2 respectively. The second part is a sketch diagram illustrating the overlapping of the first-eye-viewed image P1 and the second-eye-viewed image P2. The third part is a sketch diagram illustrating that the second-eye-viewed image P2 has been horizontally shifted to the right by N pixels, wherein N is a natural number. The fourth part is a sketch diagram illustrating that the second-eye-viewed image P2 has been horizontally shifted to the right by N pixels again. Then the horizontal difference is at a minimum, and the horizontally shifting is completed.

Therein, the horizontal difference could be calculated by accumulating the differences between the gray-scale values of the corresponding pixels after the overlapping. Nevertheless, it is not limited to this method. For example, the pixel positions for accumulating the differences between the gray-scale values could be decided by a sampling method, which could be statically decided in advance or dynamically decided afterwards. In addition, the seeking for the minimum could be stopped by an iteration method or by simply setting up a stop-seeking condition. For example, an allowable difference is set up and satisfied, the seeking is stopped, and then the horizontally shifting is completed. Alternatively, when a difference within the allowable difference cannot be obtained, the seeking is then given up. That is, the adjusting for the first-eye-viewed image P1 and the second-eye-viewed image P2 is given up. Therein, the allowable difference is the difference between two successive average horizontal differences, and the average horizontal difference is the horizontal difference divided by the calculated area, that is, the quantity of the pixels.

Because the first-eye-viewed image P1 and the second-eye-viewed image P2 are essentially different, however horizontally the second-eye-viewed image P2 is shifted, there still exists a non-zero horizontal difference between the first-eye-viewed image P1 and the second-eye-viewed image P2. Nevertheless, the horizontal difference is not a constant, but a curve with an upward open, as shown in FIG. 1C. The curve has a minimum, which means the horizontal shift amount is the best relative horizontal shift for the first-eye-viewed image P1 and the second-eye-viewed image P2. It is noticed that the final adjusted horizontal shift amount may not correspond to the lowest point in FIG. 1C, but a relatively low point at least. According to the preferred embodiment, the second-eye-viewed image P2 is shifted by N pixels per shifting. The image quality and the processing speed are balanced by setting the N value. Of course, dynamically setting the N value or other methods for deciding the shift amount are not ruled out so as to more efficiently balance the quality of the synthesized image and the processing speed.

Additionally, in a general case, the first-eye-viewed image P1 and the second-eye-viewed image P2 essentially have a horizontally relative relation. According to the preferred embodiment, the second-eye-viewed image P2 is captured from a scene from the right side. The first-eye-viewed image P1 is captured from a scene from the left side. Consequently, after overlapping the first-eye-viewed image P1 and the second-eye-viewed image P2, the first processing module 12 needs to just shift right the second-eye-viewed image P2, as shown in FIG. 1B.

Similarly, the second processing module 13 receives the overlapped image of the first-eye-viewed image P1 and the second-eye-viewed image P2, which have been horizontally shifted, from the first processing module 12. Then the second processing module 13 vertically shifts the second-eye-viewed image P2 with respect to the first-eye-viewed image P1 until a vertical difference between the first-eye-viewed image P1 and the second-eye-viewed image P2 is substantially at a minimum. It is different from the horizontally shifting. The first-eye-viewed image P1 and the second-eye-viewed image P2 do not have a relative relation in essence, so the direction of the vertically shifting could be upward or downward. The vertical difference has a similar feature to the horizontal difference; that is, the vertical difference is a curve with an upward open, as shown in FIG. 1D. In order to find out the shifting direction, the first-eye-viewed image P1 is fixed first, and then the second-eye-viewed image P2 is shifted upward or downward. The vertical differences are calculated respectively, and the direction of a relative minimum of said vertical differences is determined to be the vertically shifting direction. The calculation of the vertical differences is the same as the calculation of the horizontal differences.

Please refer to FIG. 1E. FIG. 1E is a sketch diagram illustrating the vertically shifting of the first-eye-viewed image P1 and the second-eye-viewed image P2. The sketch diagram includes three parts. The first part, which is the uppermost part of FIG. 1E, illustrates the processed result of the first processing module 12. The second part is a sketch diagram illustrating that the second-eye-viewed image P2 has been vertically shifted downward by M pixels, wherein M is a natural number. The third part is a sketch diagram illustrating that the second-eye-viewed image P2 has been horizontally shifted to the right by M pixels again. Then the vertical difference is at a minimum, and the vertically shifting is completed. The image of overlapping the first-eye-viewed image P1 and the second-eye-viewed image P2, which have been horizontally and vertically shifted, is obtained to be as the adaptive stereoscopic image.

It is worth noticing that, according to the preferred embodiment, although the second processing module 13 is coupled to the first processing module 12 and processes the information after the first processing module 12, there is the possibility that the second processing module 13 can be directly coupled to the receiving module 11 at the same stage as the first processing module 12. That is, under a condition of enough resources, the horizontally shifting and the vertically shifting can be respectively performed to obtain the horizontal shift and the vertical shift at the same time, and then the stereoscopic image is synthesized by the obtained horizontal shift and the obtained vertical shift.

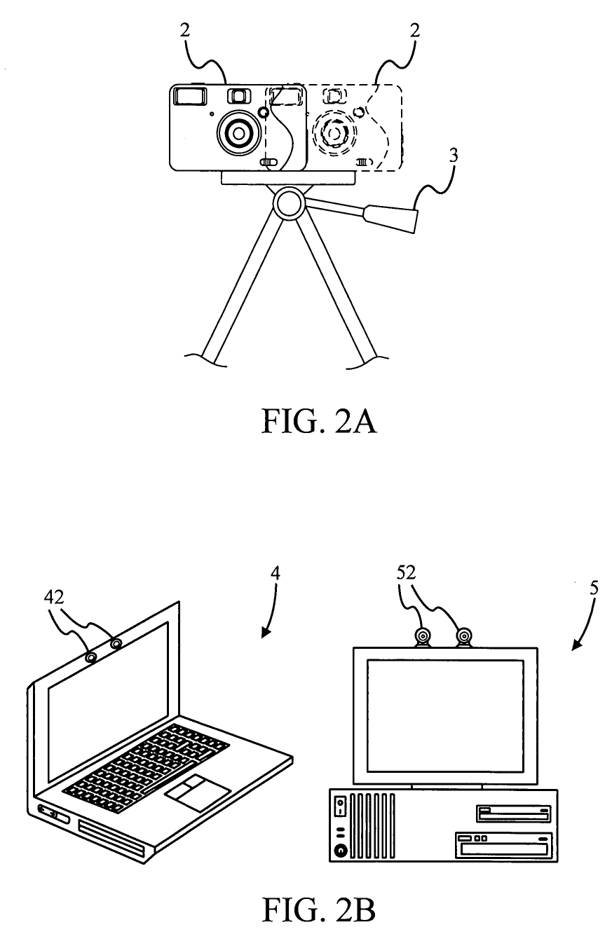

In addition, the first-eye-viewed image and the second-eye-viewed image relative to the apparatus of the invention can be captured and offered by a single-lens camera 2 with a proper tool 3. As shown in FIG. 2A, the tool (tripod) 3 can offer two different mounting positions for the single-lens camera 2 to capture the first-eye-viewed image and the second-eye-viewed image respectively. If the images are offered by a two-lens camera, the two-lens camera can simultaneously offer a first-eye-viewed image and a second-eye-viewed image. Similarly, if the images are offered by a multi-lens camera, the multi-lens camera can offer a first-eye-viewed image and a plurality of second-eye-viewed images for synthesizing a stereoscopic image or a plurality of stereoscopic images with different angles of view. Therefore, the apparatus and the method of the invention can be directly installed in a camera to directly synthesize stereoscopic images in the camera.

In addition, the apparatus and the method of the invention can be directly installed in a computer 4 and 5 with two capture devices 42 and 52, as shown in FIG. 2B. The capture devices 42 and 52 respectively capture images as first-eye-viewed image and second-eye-viewed image. In real-time video applications, before a communication starts, synthesis parameters for following stereoscopic images are set up on the basis of a first-eye-viewed image and a second-eye-viewed image captured at the first time. The parameters include the distance between the capture devices 42 and 52, the distance and the shift between the capture devices 42 and 52 and the captured object, and so on. Because the calculation is only performed at the start to obtain the parameters for the following images, the load of the real-time image transmission does not increase. Nevertheless, it is possible that the calculation is automatically or manually performed to renew the parameters at a predetermined time interval.

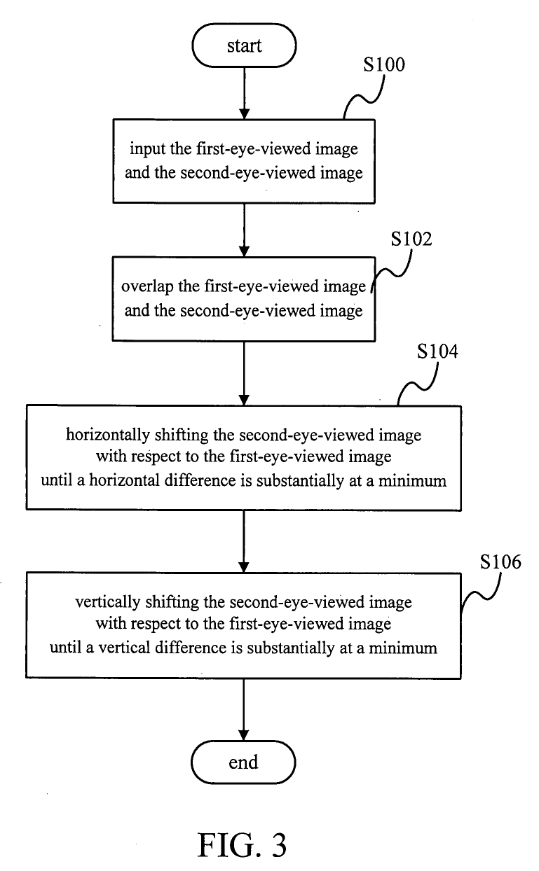

Please refer to FIG. 3. FIG. 3 is a flow chart according to the preferred embodiment. As shown in FIG. 3, the adjusting method of the invention includes: first, inputting the first-eye-viewed image and the second-eye-viewed image, as shown in step S100. Next, the method is to overlap the first-eye-viewed image and the second-eye-viewed image, as shown in step S102. Then, the method is to horizontally shift the second-eye-viewed image with respect to the first-eye-viewed image until a horizontal difference between the first-eye-viewed image and the second-eye-viewed image is substantially at a minimum, as shown in step S104. Lastly, the method is to vertically shift the second-eye-viewed image with respect to the first-eye-viewed image until a vertical difference between the first-eye-viewed image and the second-eye-viewed image is substantially at a minimum, as shown in step S106. Therein, the result of step S106 is the adaptive stereoscopic image. Furthermore, step S104 and step S106 can be concurrently performed, and the stereoscopic image is then synthesized on the basis of the horizontal shift and the vertical shift obtained in step S1104 and step S106.

Therefore, the apparatus and the method of the invention adjust the shifts of a first-eye-viewed image and a second-eye-viewed image to generate an adaptive stereoscopic image, which can efficiently synthesize stereoscopic images and improve the successful rate of image synthesis.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for generating an adaptive stereoscopic image by using a first-eye-viewed image and a second-eye-viewed image, the first-eye-viewed image and the second-eye-viewed image being captured from a scene, said method comprising the steps of:
(a) inputting the first-eye-viewed image and the second-eye-viewed image;
(b) overlapping the first-eye-viewed image and the second-eye-viewed image;
(c) horizontally shifting the second-eye-viewed image with respect to the first-eye-viewed image until a horizontal difference between the first-eye-viewed image and the second-eye-viewed image is substantially at a minimum; and
(d) vertically shifting the second-eye-viewed image with respect to the first-eye-viewed image until a vertical difference between the first-eye-viewed image and the second-eye-viewed image is substantially at a minimum, the result of step (d) being as the adaptive stereoscopic image.

2. The method of claim 1, wherein step (c) is performed by horizontally shifting the second-eye-viewed image by N pixels with respect to the first-eye-viewed image per shifting, and N is a natural number.

3. The method of claim 1, wherein step (d) is performed by vertically shifting the second-eye-viewed image by M pixels with respect to the first-eye-viewed image per shifting, and M is a natural number.

4. An apparatus for generating an adaptive stereoscopic image by using a first-eye-viewed image and a second-eye-viewed image, the first-eye-viewed image and the second-eye-viewed image being captured relative to a scene, said apparatus comprising:
a receiving module, configured to receive input of the first-eye-viewed image and the second-eye-viewed image; and
a first processing module, coupled to the receiving module, for overlapping the first-eye-viewed image and the second-eye-viewed image and horizontally shifting the second-eye-viewed image with respect to the first-eye-viewed image until a horizontal difference between the first-eye-viewed image and the second-eye-viewed image is substantially at a minimum; and
a second processing module, coupled to the first processing module, for receiving the overlapped image of the first-eye-viewed image and the second-eye-viewed image, which have been horizontally shifted, vertically shifting the second-eye-viewed image with respect to the first-eye-viewed image until a vertical difference between the first-eye-viewed image and the second-eye-viewed image is substantially at a minimum, and obtaining the overlapped image of the first-eye-viewed image and the second-eye-viewed image, which have been vertically shifted, to be the adaptive stereoscopic image.

5. The apparatus of claim 4, wherein the first processing module horizontally shifts the second-eye-viewed image by N pixels with respect to the first-eye-viewed image per shifting, and N is a natural number.

6. The apparatus of claim 4, wherein the second processing module vertically shifts the second-eye-viewed image by M pixels with respect to the first-eye-viewed image per shifting, and M is a natural number.
